(19) United States
(12) Patent Application Publication
(10) Pub. No.: US 2024/0416440 A1
(43) Pub. Date: Dec. 19, 2024

(54) FINGER RING CUTTING APPARATUS AND METHOD

(71) Applicant: Jeffrey Gerton, Fox Island, WA (US)

(72) Inventor: Jeffrey Gerton, Fox Island, WA (US)

(21) Appl. No.: 18/672,376

(22) Filed: May 23, 2024

Related U.S. Application Data
(60) Provisional application No. 63/521,185, filed on Jun. 15, 2023.

(51) Int. Cl. B23D 49/11; B23D 51/16; B23D 59/00; B23D 61/00; B23Q 11/12

(52) U.S. Cl. CPC B23D 49/11; B23D 51/16; B23D 59/001; B23D 61/006; B23Q 11/126

(57) ABSTRACT

A ring cutter for removing an ornamental ring encircling a person's finger is disclosed. The ring cutter includes an oscillating hand-held multi-tool with a blade substantially oriented at a right angle that oscillates to cut the ring. The oscillating blade has an oscillating amplitude small enough to avoid any injury to the finger. The ring cutter further includes a tissue depressor and guard attached to the head portion of the ring cutter and functions to push down the swollen tissues that surround the ring that need to be cut and help in avoiding finger injury. The ring cutter further includes a sprayer assembly to deliver a jet of cooling liquid (such as water) to cool down the ring and blade and prevent any thermal burn during the cutting operation.

### CROSS-REFERENCE TO RELATED APPLICATIONS

The present application hereby claims priority to and incorporates by reference the entirety of the disclosures of the provisional application No. 63/521,185, entitled “FINGER RING CUTTING APPARATUS AND METHOD” filed on 15 JUN. 2023.

### TECHNICAL FIELD

The present invention relates generally to cutting devices. Particularly, the present invention is directed to a finger ring cutting apparatus or a ring cutter for removing an ornamental ring encircling a person's finger.

### BACKGROUND

Several situations exist in which removing a finger ring from the finger on which it is worn requires cutting the ring through at least one side, or wall, of the ring. There could be several reasons for the removal of the ring, for example, over time, the ring that's worn for a long time by a user may become tight and can cause the finger of the user to swell restricting the movement of the ring off the finger in a conventional fashion, if the user wishes to slide off the ring.

Further, many people, through accident or other events (E.g., infection) may experience swelling of hands and fingers rapidly. If the person is wearing a ring or bracelet, such swelling may cause the person extra pain, and the ring or bangle may interfere with any medical procedure which will be undertaken with regard to the patient. Thus, the ring must be removed from the patient's finger. However, the removal of the ring in such situations can be an extremely painful procedure and may hurt the finger tissue around the ring.

Although the present inventor is aware of devices for removing finger rings, such as disclosed in U.S. Pat. No. 9,414,653B1 to Steven D. Morton, CN212634559U to Huang Xuewei, U.S. Pat. No. 4,976,034 Anthony T. Whitman, U.S. Ser. No. 10/118,306 to Scimone et al. None of these devices operate as fast as necessary for a patient's comfort. Furthermore, none of these devices are designed to offer optimum safety and minimize the risk of thermal burn from heat generation from the blade.

Furthermore, the traditional devices use a rotary wheel or grinder for cutting down the ring which at times can injure or cut the finger tissues surrounding the ring. Additionally, the existing cutter devices require a separate guard to be placed underneath the ring to prevent injury from the blade. Placing a guard underneath the ring is difficult and painful and can cause tissue injury. Further, existing cutter devices require complete manual manipulation of the device to cut the ring. Such manual manipulation may cause the cutting device to move from its position thereby causing further pain as the operator manually manipulates the cutting device during the cutting procedure.

### SUMMARY

Accordingly, there is a need for a device for removing rings from the fingers of a user. The device can be used for removing a ring from a finger rapidly and steadily. However, this should not be considered as a limitation of the proposed tool, the proposed tool herein may be used for any kind of ornamental ring encircling a portion of a person's anatomy, such as a finger ring, a bracelet, a bangle, or the like.

It is an objective of the present invention to provide a finger ring-cutting apparatus that is safe to use without hurting the finger.

It is another object of the present invention to provide an apparatus for removing a ring from a finger in a safe manner that permits complete removal of the ring without subjecting the patient to being contacted by the sharp edges of the cut ring.

Another object of the present invention is to provide a ring cutting apparatus with a tissue depressor and guard to push down the swollen tissues that surround the ring that needs to be cut. The tissue depressor and guard may be fixedly attached or removably attached to the ring-cutting apparatus. The tissue depressor and guard may or may not go slightly under the ring in order to safeguard the finger during the cutting operation. The tissue depressor and guard may have a spring mechanism or other locking mechanism to removably grip the ring during the cutting operation.

Furthermore, the ring-cutting apparatus uses a reciprocating or oscillating blade for cutting and removal of the ring from a finger. The oscillating blade's oscillation amplitude is small enough such that the blade is safe for operation without risking cutting skin while cutting the ring. The oscillating ring cutter selectively cuts the metal of the ring. The ring cutter also employs a sprayer assembly to deliver a jet of cooling liquid to cool down the ring and blade and prevent any thermal burn.

These and other features and advantages of the present invention will become apparent from the detailed description below, in light of the accompanying drawings

### BRIEF DESCRIPTION OF THE DRAWINGS

In the drawings:

FIG. 1 illustrates an exemplary finger ring-cutting apparatus or ring cutter configured in the form of a handheld power tool, according to an embodiment of the present invention.

FIG. 2 specifically illustrates the engagement of an oscillating blade of the finger ring cutting apparatus underside of a head portion of the finger ring cutting apparatus.

FIG. 3 illustrates an exemplary finger ring-cutting apparatus with a skin depressor and guard, and a sprayer assembly, according to one exemplary embodiment.

FIG. 4 illustrates a use case scenario of the finger ring cutting apparatus of FIG. 3.

### DETAILED DESCRIPTION

Before describing the present invention in detail, it should be observed that the present invention utilizes a combination of components or processes, which constitutes a finger ring-cutting apparatus and its method of operation. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

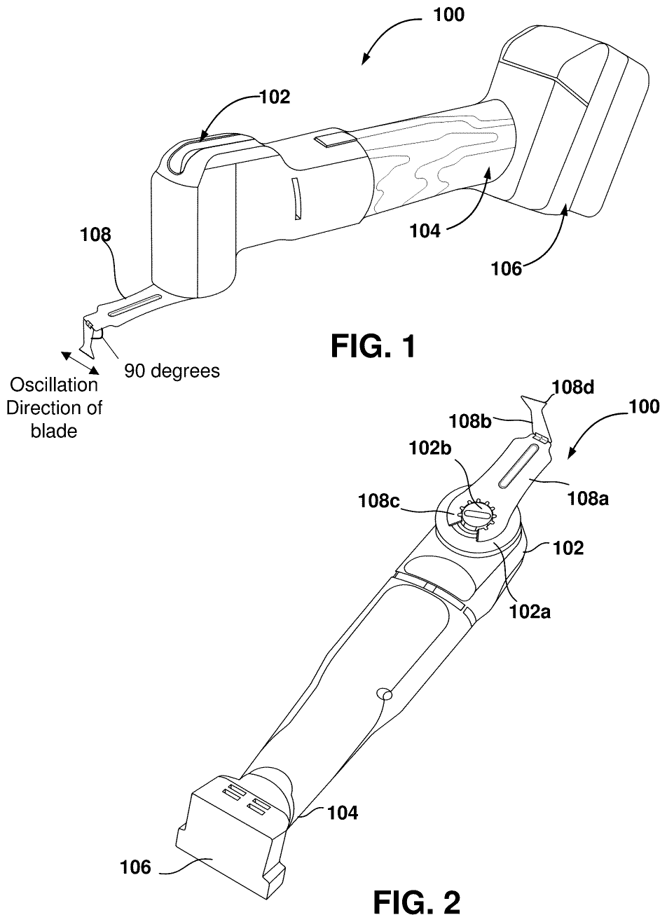

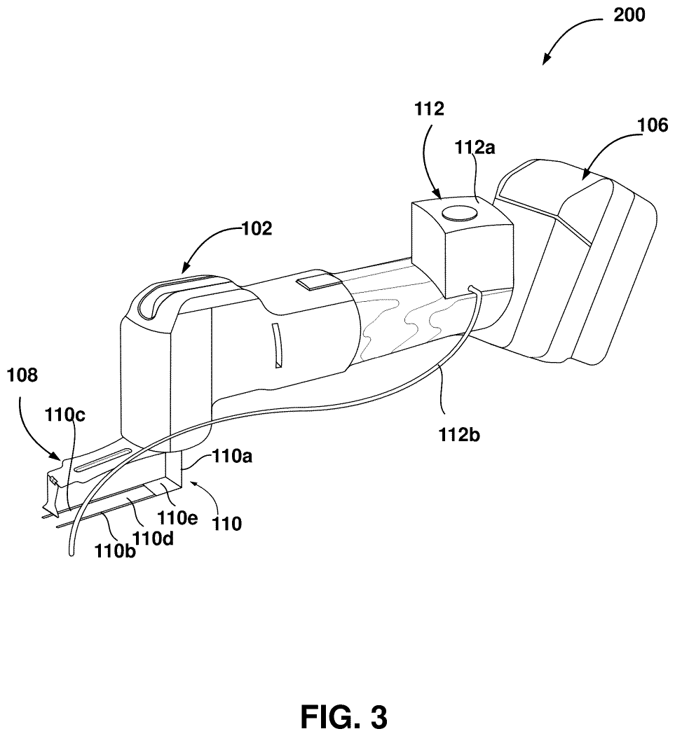

The finger ring-cutting apparatus or ring cutter of the present invention will now be described with reference to the accompanying drawings, particularly FIGS. 1-4.

Embodiments of a ring cutter, generally 100, structured according to certain principles of the invention are illustrated in FIGS. 1 through 4. Ring cutter 100 is particularly configured to facilitate cutting a jewellery ring from the finger of a human. The simplified version of the ring cutter 100 of the present disclosure is shown in FIGS. 1-2.

The ring cutter 100 may be made and designed to be user-friendly just like any handheld oscillating multi-tools available on the market, such as for example Milwaukee®, Ridgid®, Ryobi®, and so on. The ring cutter 100 includes a body consisting of a head portion 102 and a tail portion 104. The body is ergonomically shaped for ease of grasping by a user or operator of the ring cutter 100. The head portion 102 includes a blade engaging interface 102a for connecting or disconnecting an oscillating multitool blade 108. In an embodiment, the blade engaging interface 102a is configured underside of the head portion 102 (FIG. 2). The blades 108 engaging the blade engaging interface 102a are replaceable. The ring cutter 100 may include a blade engagement and disengagement controller (not seen). The blade engagement and disengagement controller may include a lever or other similar provision to allow quick and easy engagement and disengagement of the blade 108 to and from the blade engaging interface 102a.

The blade 108 according to an embodiment of the present invention is designed ideally with 90 degrees angle. The blade 108 includes a first arm 108a having an anchor portion 108c (star-shaped or partial star-shaped (or open lock configuration) or any other shapes). The anchor portion 108c of blade 108 engages with a locking tab 102b of the blade engaging interface 102a as shown in FIG. 2. The blade 108 further includes a second arm 108b connected at a right angle to the first arm 108a at its one end and carrying cutting teeth 108d at the other end. In order to change or replace the blade 108 with a new one, a user simply needs to pull in the lever or other mechanism provided for the purpose of engaging and disengaging the blade 108 from the cutter 100. The blade 108 may be made of suitable material or a combination of materials to be able to cut down different metal types used for rings or other jewelry. For example, the blade may be made of a tungsten carbide to cut ring materials as hard as titanium, or the blade may be a diamond blade that may be required to cut a tungsten carbide or ceramic ring.

The ring cutter 100 of the present invention includes a power source. In an embodiment, the power source may be a rechargeable battery 106 that can be mounted and/or dismounted from the tail portion 104 of the body of the cutter 100 to power the ring cutter 100. According to another embodiment (not shown), the cutter 100 may be configured in a wired version that can be plugged into a power outlet (provided at a facility where the cutter 100 is operated) to power the ring cutter 100.

Furthermore, the cutter or tool 100 internally houses a motor (not seen) to oscillate the blade 108 rapidly to facilitate faster cutting. The speed of the motor or the blade 108 may be controllable using some buttons or knob/dial provided on the cutter 100. The cutter device 100 may further include many other features such as a light source to make the visibility of the cutting object (such as a finger ring) better in low lighting conditions.

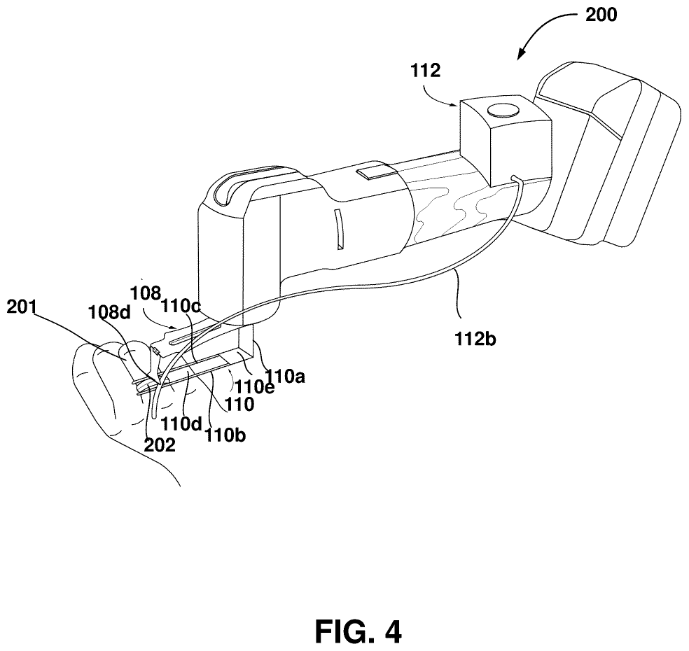

In operation, the tip of the blade or teeth 108d is first placed in a 90-degree orientation as shown in FIG. 4 and the cutter 100 is then held by the user/operator of the ring cutter 100 in his hand and switched on to oscillate the blade rapidly to cut the ring 202. Since the oscillation amplitude of the blade is small enough or substantially small, it ensures little to no injury to the finger by the blade.

For better safety and to avoid the risk of thermal burn of the finger tissues around the ring 202, when the ring cutter 100 is used for cutting the ring 202, the inventor herein proposes another embodiment of the tool referred to as a ring cutter 200. The ring cutter 200 is essentially the same as cutter 100 with added tissue depressor and guard 110. The tissue depressor and guard 110 comprises a back portion 110a attachable to the head portion 102 of the cutter 200. The tissue depressor and guard 110 may be fixedly attached to the head portion or removably attached thereto and function to push down the swollen tissues that surround the ring that needs to be cut. The tissue depressor and guard 110 or (or a plurality of elongated teeth 110b,110c) are configured to go slightly under or configured to not go under the ring 202 in order to safeguard the finger during the cutting operation according to some embodiments. The tissue depressor and guard 110 may have a spring mechanism or other locking mechanism (not seen) to removably grip the ring 202 worn around the finger 201 during the cutting operation. As seen, the tissue depressor and guard 110 may resemble a fork consisting of a back portion 110a, a plurality of elongated teeth 110b,110c spaced apart to form a space 110d sufficient to hold the ring 202 from two sides and help in pressing down the skin surrounding the ring 202 and letting the blade do its job without risking any injury to the skin surrounding the ring 202. As seen, the elongated teeth 110b,110c are attached to an end of the back portion 110a at a 90 degrees using an intermediate connecting plate 110e. Although a specific configuration for the blade 108 and the fork-like elongated teeth 110b,110c is shown, it should be understood that the blade 108 may be shaped more straight if the fork-like elongated teeth 110b,110c were designed differently. In other words, the elongated teeth 110b,110c are shaped such as to complement the shape of the oscillating multitool blade 108.

The ring cutter 200 further includes a sprayer assembly 112 to deliver a jet of cooling liquid (such as water) to cool down the ring 202 and blade 108 and prevent any thermal burn. The sprayer assembly 112 is preferably configurable on the head portion 102 or the tail portion 104. During the cutting operation of the ring 202, it is evident that the ring and the blade 108 get heated up and can cause thermal burn to the skin or tissues of the finger 201 surrounding the ring 202. To avoid that, the ring cutter 200 may be equipped with sprayer assembly 112. The assembly 112 essentially consists of a reservoir 112a (with a predefined volume) with a pump (not seen) and a tube 112b connected to the reservoir for delivering fluid content from the reservoir 112a. During the cutting operation of the ring 202, the user/operator of the ring cutter 200 can pump out fluid (water or other cooling liquid) or it can be automated and delivered onto the ring 202 and blade 108 to cool them down to not let them get overheated causing any thermal burn. The delivery of the fluid out of reservoir 112a may be controllable using some switch or other similar provisions provided on the sprayer assembly 112.

In operation, as seen in FIG. 4 and assuming the reservoir of sprayer assembly 112 is filled with water, firstly, the user orients the tissue depressor and guard 110 to make sure it catches the ring 202 (to be cut) from two sides and grips the ring 202 properly. Then the user applies some force using the tissue depressor and guard 110 to push down the skin/tissues surrounding the ring 202. Thereafter, the teeth 108d of the blade 108 is oriented 90 degrees on the surface of the ring 202 and the ring cutter 200 is switched on. Upon switching on the ring cutter 200, the blade 108 starts oscillating rapidly to cut the metal of the ring 202. Since the oscillation amplitude of the blade 108 is small enough, it ensures little to no injury to the finger by the blade 108. To reduce the heat or cool the ring 202 and the blade 108, the user can pump the water out of the reservoir 112a of the sprayer assembly 112 using the tube 112b and deliver the water to the ring 202 as well as the blade 108 surfaces to cool both of them and avoid the thermal burn. Lastly, the cut ends of the ring 202 are pulled apart in order to remove the ring 202 out of the user's finger 201.

The ring cutter itself or any components thereof including blade and tissue depressor and guard 110 and the sprayer assembly 112 and any other components may be made in different sizes and using various materials known in the art and thus, size, the material of use should not be construed as any limitation.

Although particular embodiments of the invention have been described in detail for purposes of illustration, various modifications, and enhancements may be made without departing from the spirit and scope of the invention.

1. A ring cutter (100,200), comprising:
a body comprising a head portion (102), and a tail portion (104), wherein the head portion (102) comprises a blade engaging interface (102a) for connecting and/or disconnecting an oscillating multitool blade (108) engaged thereto;
a power source for powering the ring cutter (100); and
a motor to oscillate the oscillating multitool blade (108) rapidly to facilitate the cutting of a ring (202), wherein the speed of the oscillating multitool blade (108) is controllable by controlling the speed of the motor.

2. The ring cutter (100,200) of claim 1 further comprises a blade engagement and disengagement controller including at least a lever to allow quick and easy engagement and disengagement of the oscillating multitool blade (108) to and from the blade engaging interface (102a).

3. The ring cutter (100,200) of claim 1, wherein the oscillating multitool blade (108) comprising
a first arm (108a) having an anchor portion (108c), wherein the anchor portion (108c) of the oscillating multitool blade (108) engages with a locking tab (102b) of the blade engaging interface (102a); and
a second arm (108b) connected at a ring angle to the first arm (108a) at one end and carrying cutting teeth (108d) at the opposing other end.

4. The ring cutter (100,200) of claim 1, wherein the oscillating multitool blade (108) is made using at least a tungsten carbide, and a diamond.

5. The ring cutter (100,200) of claim 1, wherein the power source is a rechargeable battery (106) mountable and/or dismountable from the tail portion (104) of the body of the ring cutter (100,200).

6. The ring cutter (100,200) of claim 1, wherein the power source is a power outlet provided at a facility where the ring cutter (100) is operated.

7. The ring cutter (100,200) of claim 1 further comprises a light source to make the visibility of the ring (202) better in low lighting conditions.

8. The ring cutter (100,200) of claim 1 further comprises a tissue depressor and guard (110) functionally configured to push down tissues of a finger (201) surrounding the ring (202) intended to be cut.

9. The ring cutter (100,200) of claim 8, wherein the tissue depressor and guard (110) comprising
a back portion (110a) having a first end and a second end, wherein the back portion (110a) is attached to the head portion (102) of the ring cutter (100,200) using the first end; and
a plurality of elongated teeth (110b,110c) spaced apart to form at least one space (110d) sufficient to hold the ring (202) from the sides and configured to push down tissues of the finger (201) surrounding the ring (202) while the oscillating multitool blade (108) is operational.

10. The ring cutter (100,200) of claim 9, wherein the plurality of elongated teeth (110b,110c) are attached to the second end of the back portion (110a) at 90 degrees using an intermediate connecting plate (110e).

11. The ring cutter (100,200) of claim 9, wherein the plurality of elongated teeth (110b,110c) are configured to go under the ring 202 in order to safeguard the finger during the cutting operation of the ring 202.

12. The ring cutter (100,200) of claim 9, wherein the tissue depressor and guard (110) comprises a spring mechanism or locking mechanism to removably grip the ring (202) worn around the finger (201) during the cutting operation.

13. The ring cutter (100,200) of claim 1 further comprises a sprayer assembly (112) configured on the head portion (102) or the tail portion (104) to deliver a jet of cooling liquid to cool down the ring (202) and the oscillating multitool blade (108) during the cutting operation and prevent any thermal burn.

14. The ring cutter (100,200) of claim 1, wherein the sprayer assembly (112) comprises a reservoir (112a) for holding a predefined volume of cooling liquid, a pump, and a tube (112b) connected to the reservoir for delivering fluid content from the reservoir (112a) onto the ring (202) and the oscillating multitool blade (108) during the cutting operation.

15. The ring cutter (100,200) of claim 9, wherein the plurality of elongated teeth (110b,110c) are shaped such as to complement the shape of the oscillating multitool blade (108).

16. The ring cutter (100,200) of claim 1, wherein the oscillating multitool blade (108) oscillation amplitude of the blade 108 is substantially small to ensure no injury is caused to the finger by the oscillating multitool blade (108).

17. A ring cutter (200), comprising:
a body comprising a head portion (102), and a tail portion (104), wherein the head portion (102) comprises a blade engaging interface (102a) for connecting and/or disconnecting an oscillating multitool blade (108) engaged thereto;
a power source for powering the ring cutter (100);
a motor to oscillate the oscillating multitool blade (108) rapidly to facilitate the cutting of a ring (202), wherein the speed of the oscillating multitool blade (108) is controllable by controlling the speed of the motor; and
a tissue depressor and guard (110) functionally configured to push down tissues of a finger (201) surrounding the ring (202) intended to be cut.

18. The ring cutter (200) of claim 17, wherein the tissue depressor and guard (110) comprising
a back portion (110a) having a first end and a second end, wherein the back portion (110a) is attached to the head portion (102) of the ring cutter (100,200) using the first end; and
a plurality of elongated teeth (110b,110c) spaced apart to form at least one space (110d) sufficient to hold the ring (202) from the sides and configured to push down tissues of the finger (201) surrounding the ring (202) while the oscillating multitool blade (108) is operational.

19. The ring cutter (200) of claim 17 further comprising a sprayer assembly (112) comprises a reservoir (112a) for holding a predefined volume of cooling liquid, a pump, and a tube (112b) connected to the reservoir for delivering fluid content from the reservoir (112a) onto the ring (202) and the oscillating multitool blade (108) during the cutting operation.

20. The ring cutter (200) of claim 17, wherein the oscillating multitool blade (108) comprising
a first arm (108a) having an anchor portion (108c), wherein the anchor portion (108c) of the oscillating multitool blade (108) engages with a locking tab (102b) of the blade engaging interface (102a); and
a second arm (108b) connected at a ring angle to the first arm (108a) at one end and carrying cutting teeth (108d) at the opposing other end.

21. A ring cutter (200), comprising:
a body comprising a head portion (102), and a tail portion (104), wherein the head portion (102) comprises a blade engaging interface (102a) for connecting and/or disconnecting an oscillating multitool blade (108) engaged thereto;
a power source for powering the ring cutter (100);
a motor to oscillate the oscillating multitool blade (108) rapidly to facilitate the cutting of a ring (202), wherein the speed of the oscillating multitool blade (108) is controllable by controlling the speed of the motor; and
a tissue depressor and guard (110) functionally configured to push down tissues of a finger (201) surrounding the ring (202) intended to be cut; and
a sprayer assembly (112) comprises a reservoir (112a) for holding a predefined volume of cooling liquid, a pump, and a tube (112b) connected to the reservoir for delivering fluid content from the reservoir (112a) onto the ring (202) and the oscillating multitool blade (108) during the cutting operation.
